(19) United States
(12) Patent Application Publication
(10) Pub. No.: US 2025/0372640 A1
(43) Pub. Date: Dec. 4, 2025

(54) METHOD OF PRODUCING POSITIVE ELECTRODE ACTIVE MATERIAL, METHOD OF PRODUCING POSITIVE ELECTRODE PLATE, AND METHOD OF PRODUCING NON-AQUEOUS ELECTROLYTE SECONDARY BATTERY

(71) Applicant: Prime Planet Energy & Solutions, Inc., Tokyo (JP)

(72) Inventor: Shoji NONAKA, Takasago-shi (JP)

(21) Appl. No.: 19/218,373

(22) Filed: May 26, 2025

(30) Foreign Application Priority Data
May 31, 2024 (JP) 2024-089026

(51) Int. Cl. H01M 4/525; C01G 53/44

(52) U.S. Cl. CPC H01M 4/525; C01G 53/44; C01P 2002/52; C01P 2006/40

(57) ABSTRACT

A method of producing a positive electrode active material includes calcinating a mixture of a nickel-containing compound and a lithium compound introduced into a furnace of a rotary kiln at 750 to 1000° C. under an oxygen atmosphere. The nickel-containing compound is at least one of a nickel-containing hydroxide and a nickel-containing oxide. A layer of yttrium-chromium composite oxide is formed on an outermost surface of an inner wall of the furnace.

### CROSS REFERENCE TO RELATED APPLICATIONS

This nonprovisional application is based on Japanese Patent Application No. 2024-089026 filed on May 31, 2024 with the Japan Patent Office, the entire contents of which are hereby incorporated by reference.

### BACKGROUND OF THE INVENTION

### Field of the Invention

The present invention relates to a method of producing a positive electrode active material, a method of producing a positive electrode plate, and a method of producing a non-aqueous electrolyte secondary battery.

### Description of the Background Art

A positive electrode active material used in a lithium secondary battery is produced through calcination in a calcination furnace. For example, Japanese Patent Laying-Open No. 2022-146357 discloses that an aluminum oxide is formed on an outermost layer of an inner wall of a core tube composed of an alloy because there is a possibility that a metal component may be introduced into a source material when the core tube is used for a long period of time.

### SUMMARY OF THE INVENTION

The present disclosure provides a method of producing a positive electrode active material so as to suppress introduction of Cr, which is an impurity, even when a rotary kiln having a furnace composed of a material including an alloy including Cr is used.

[1] A method of producing a positive electrode active material including a lithium transition metal composite oxide, the method comprising calcinating a mixture of a nickel-containing compound and a lithium compound introduced into a furnace of a rotary kiln at 750 to 1000° C. under an oxygen atmosphere, wherein
the nickel-containing compound is at least one of a nickel-containing hydroxide and a nickel-containing oxide, and
a layer of yttrium-chromium composite oxide is formed on an outermost surface of an inner wall of the furnace.

[2] The method of producing a positive electrode active material according to [1], wherein
the layer coats a base material layer of the furnace, and
the base material layer is composed of an alloy including Cr.

[3] The method of producing a positive electrode active material according to [2], wherein the layer is formed by performing thermal spraying of yttria onto the base material layer.

[4] The method of producing a positive electrode active material according to [2] or [3], wherein the alloy including the Cr further includes Fe and Ni.

[5] The method of producing a positive electrode active material according to any one of [1] to [4], further comprising obtaining a molded body by molding the mixture, wherein
in the calcinating, the molded body is calcinated.

[6] The method of producing a positive electrode active material according to any one of [1] to [5], wherein the lithium compound is at least one of lithium hydroxide and lithium carbonate.

[7] The method of producing a positive electrode active material according to any one of [1] to [6], wherein a content of Cr in the lithium transition metal composite oxide is 1 ppm or less.

[8] The method of producing a positive electrode active material according to any one of [1] to [7], wherein the lithium transition metal composite oxide includes Li, Ni, and Mn.

[9] The method of producing a positive electrode active material according to any one of [1] to [8], wherein
the lithium transition metal composite oxide includes Li, Ni, Mn, Co, and M, the M being one or more metal elements selected from a group consisting of Mg, Ca, Al, Ti, V, Cr, Fe, Cu, Zn, Zr, Nb, Mo, Ta, W, and Y, and
a molar ratio of the Li, the Ni, the Mn, the Co, and the M is Li:Ni:Mn:Co:M=a:x:y:z:t, where the a, the x, the y, the z, and the t satisfy 1.0≤a≤1.3, x+y+z+t=1, 0.25≤x≤0.9, 0<y≤0.6, 0<z≤0.6, and 0<t≤0.1.

[10] A method of producing a positive electrode plate using a positive electrode active material, wherein
the positive electrode active material is produced by the method of producing a positive electrode active material according to any one of [1] to [9].

[11] A method of producing a non-aqueous electrolyte secondary battery including a positive electrode plate, wherein
the positive electrode plate is produced by the method of producing a positive electrode plate according to [10].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart showing an exemplary method of producing a positive electrode active material according to an embodiment.

FIG. 2 is a flowchart showing another exemplary method of producing a positive electrode active material according to the embodiment.

### DESCRIPTION OF THE PREFERRED EMBODIMENTS

In the present specification, a numerical range such as “m to n” includes the lower and upper limit values unless otherwise stated particularly. That is, “m to n” indicates a numeric value range of “m or more and n or less”. A numerical value freely selected from the numerical range may be employed as a new lower or upper limit value. For example, a new numerical range may be set by freely combining a numerical value described in the numerical range with a numerical value described in another portion of the present specification, table or figure.

### Method (1) of Producing Positive Electrode Active Material

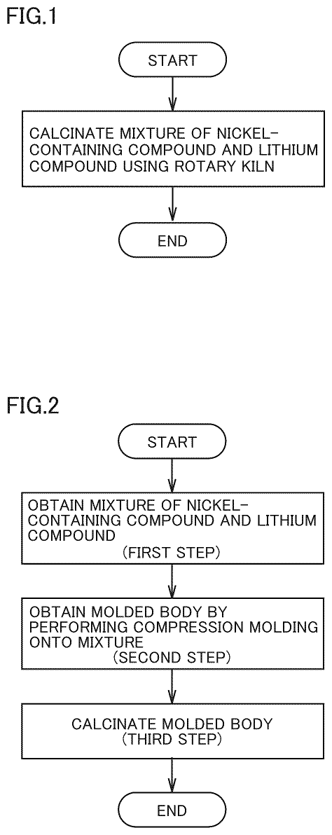

Each of FIGS. 1 and 2 is a flowchart showing an exemplary method of producing a positive electrode active material according to an embodiment. A positive electrode active material produced by the method of producing a positive electrode active material according to the present embodiment (hereinafter, also referred to as “the present method”) is used for a positive electrode plate of a non-aqueous electrolyte secondary battery (hereinafter, also referred to as “secondary battery”) such as a lithium ion battery.

The positive electrode active material produced by the present method includes a first lithium transition metal composite oxide (lithium transition metal composite oxide) (hereinafter, also referred to as “first composite oxide”). A content of Cr in the first composite oxide is preferably 50 ppm or less, may be 25 ppm or less, may be 10 ppm or less, may be 5 ppm, is more preferably 1 ppm or less, or may be 0.9 ppm or less. The content of Cr in the first composite oxide refers to a mass ratio thereof to a total mass of the first composite oxide. The content of Cr in the first composite oxide can be adjusted by, for example, producing the positive electrode active material by the present method described below.

The composition of the first composite oxide is not particularly limited, but the first composite oxide preferably includes Ni and Mn each serving as a transition metal, in addition to Li. The first composite oxide more preferably includes Li, Ni, Mn, Co, and M, the M being one or more metal elements selected from a group consisting of Mg, Ca, Al, Ti, V, Cr, Fe, Cu, Zn, Zr, Nb, Mo, Ta, W, and Y, and
a molar ratio of the Li, the Ni, the Mn, the Co, and the M is Li:Ni:Mn:Co:M=a:x:y:z:t, where the a, the x, the y, the z, and the t satisfy 1.0≤a≤1.3, x+y+z+t=1, 0.25≤x≤0.9, 0<y≤0.6, 0<z≤0.6, and 0<t≤0.1.

The molar ratio of Li is 1.0≤a≤1.3, may be 1.00≤a≤1.25, may be 1.01≤a≤1.20, may be 1.03≤a≤1.15, or may be 1.04≤a≤1.10. The molar ratio of Ni is 0.25≤x≤0.9, may be 0.25≤x≤0.90, may be 0.30≤x≤0.90, may be 0.40≤x≤0.88, or may be 0.50≤x≤0.85. The molar ratio of Mn is 0<y≤0.6, may be 0.00<y≤0.60, may be 0.05≤y≤0.50, may be 0.08≤y≤0.30, or may be 0.10≤y≤0.20. The molar ratio of Co is 0<z≤0.6, may be 0.00<z≤0.60, may be 0.00<z≤0.50, may be 0.01≤z<0.30, or may be 0.02≤z≤0.10. The molar ratio of M is 0<t≤0.1, may be 0<t≤0.08, may be 0.001≤t≤0.05, may be 0.000<t≤0.100, or may be 0.002≤t≤0.010. When the first composite oxide includes two or more metal elements M, the molar ratio of M refers to the total amount of the two or more metal elements.

The composition of the first composite oxide can be adjusted by a type of source material to be used when producing the first composite oxide and a blending amount of the source material. The composition of the first composite oxide can be determined by ICP (Inductively Coupled Plasma) atomic emission spectrometry (ICP-AES).

The positive electrode active material may include only the first composite oxide, or may include an active material other than the first composite oxide. The content of the first composite oxide in the positive electrode active material may be 85 to 100 mass %, 90 to 100 mass %, 92 to 99 mass %, or 95 to 98 mass % with respect to the total amount of the positive electrode active material.

As shown in FIG. 1, the present method includes a step (hereinafter, also referred to as “calcination step”) of calcinating a mixture of a nickel-containing compound and a lithium compound introduced into a furnace of a rotary kiln at 750 to 1000° C. under an oxygen atmosphere. In the present method, the nickel-containing compound is at least one of a nickel-containing hydroxide and a nickel-containing oxide, and a layer (hereinafter, also referred to as “YCrO₃ layer”) of yttrium-chromium composite oxide (hereinafter, also referred to as “YCrO₃”) is formed on the outermost surface of the inner wall of the furnace.

In the present method, the mixture of the nickel-containing compound and the lithium compound is calcinated using the rotary kiln having the furnace having the inner wall with the outermost surface on which the YCrO₃ layer is formed. Since the YCrO₃ has low reactivity with the lithium compound, reaction between the lithium compound and the YCrO₃ on the outermost surface of the inner wall of the furnace can be suppressed, thereby suppressing corrosion of the inner wall of the furnace. Thus, Cr included in the inner wall of the furnace can be suppressed from being introduced into the first composite oxide as an impurity, with the result that the first composite oxide having the Cr content in the range described above is readily obtained. Moreover, since the YCrO₃ layer is less likely to be cracked even in the calcination temperature range of the mixture, the rotary kiln used in the present method is also excellent in durability of the furnace.

Each of the nickel-containing compound and the lithium compound included in the mixture to be calcinated in the calcination step of the present method is a compound serving as a source material for the composite oxide. The mixture is generally in a powder or particle form.

The nickel-containing compound is at least one of a nickel-containing hydroxide and a nickel-containing oxide, and more preferably includes or is the nickel-containing oxide. The nickel-containing compound may include a metal element other than Ni in addition to Ni, preferably includes a transition metal element other than Ni, more preferably includes at least one of Mn and Co, and may include Mn and Co. The content of Cr in the nickel-containing compound is preferably 0.001 mass % or less, and may be 0.0001 mass % or less.

The nickel-containing hydroxide is preferably a nickel composite hydroxide including Ni and a metal element other than Ni. The nickel-containing oxide is preferably a nickel composite oxide including Ni and a metal element other than Ni. The metal element other than Ni and included in each of the nickel composite hydroxide and the nickel composite oxide is preferably a transition metal element other than Ni, is more preferably at least one of Mn and Co, and may be Mn and Co. The nickel-containing compound is preferably the nickel composite oxide.

Examples of the lithium compound include one or more selected from a group consisting of lithium hydroxide, lithium carbonate, lithium nitrate, and lithium acetate. The content of Cr in the lithium compound is preferably 0.001 mass % or less, or may be 0.0001 mass % or less. The lithium compound is preferably at least one of the lithium hydroxide and the lithium carbonate, and is more preferably the lithium hydroxide. The lithium compound may be an anhydride or a hydrate. When the lithium compound is the lithium hydroxide, the lithium hydroxide may be lithium hydroxide anhydrous or may be lithium hydroxide hydrate. Examples of the lithium hydroxide hydrate include lithium hydroxide monohydrate.

The average particle size (D50) of the lithium compound is, for example, 3 to 20 μm, may be 5 to 18 μm, or may be 8 to 15 μm. In the present specification, the average particle size is a particle size (D50) corresponding to 50% of cumulation of frequencies from the smallest particle size in a volume-based particle size distribution. The volume-based particle size distribution can be measured by a laser diffraction type particle size distribution measurement apparatus.

The content of each of the nickel-containing compound and the lithium compound in the mixture may be set to obtain the first composite oxide having the intended composition.

The rotary kiln used in the present method can be of the external heating type. As long as the YCrO₃ layer is formed on the outermost surface of the inner wall of the furnace of the rotary kiln, the furnace may be entirely composed of YCrO₃, or a portion of the furnace other than the YCrO₃ layer may be composed of a material other than YCrO₃. For example, the furnace may have a base material layer composed of an alloy including Cr, and a YCrO₃ layer that coats the base material layer and that is formed on the outermost surface of the furnace on the inner wall side. When the YCrO₃ layer coats the base material layer, the thickness of the YCrO₃ layer may be, for example, 10 to 1000 nm, 50 to 900 nm, or 100 to 800 nm. When the YCrO₃ layer coats the base material layer, the YCrO₃ layer preferably coats the entire surface of the base material layer on the inner wall side of the furnace, but the YCrO₃ layer may coat 80% or more, 90% or more, or 95% or more of the entire surface of the base material layer on the inner wall side of the furnace. When a ratio of coating with the YCrO₃ layer is within the above range, Cr is readily suppressed from being introduced into the first composite oxide as an impurity.

The base material layer is preferably composed of an alloy including Cr. The alloy including Cr may include, in addition to Cr, one or more metals selected from a group consisting of Fe, Ni, Mn, and Mo, and preferably includes Fe and Ni. The alloy including Cr may include a non-metal element such as Si, P, S, or C as long as the alloy exhibits a property as an alloy. Examples of the alloy including Cr include at least one of SUS310S and SUS316L.

A method of forming the YCrO₃ layer is not particularly limited. When the inner wall of the furnace has the base material layer composed of the alloy including Cr and the YCrO₃ layer that coats the base material layer, the YCrO₃ layer can be formed by performing thermal spraying of yttria (yttrium oxide; hereinafter, also referred to as “Y₂O₃”) onto the base material layer. By performing the thermal spraying of Y₂O₃ onto the base material layer, the Cr in the base material layer and the thermal-sprayed Y₂O₃ are composited, thereby forming the YCrO₃ layer on the outermost layer of the inner wall of the furnace. Since the Cr in the base material layer and the thermal-sprayed Y₂O₃ are composited, the YCrO₃ layer is less likely to be detached from the base material layer.

The YCrO₃ layer can be formed, for example, as follows. First, thermal spraying of Y₂O₃ powder is performed onto the base material layer to form the Y₂O₃ layer, thereby obtaining a stack of the base material layer and the Y₂O₃ layer. The thickness of the Y₂O₃ layer is, for example, 50 to 200 μm, or may be 80 to 150 μm. Next, the stack is calcinated and then left to be cooled so as to diffuse Y₂O₃ in the chromium oxide layer precipitated on the base material, thereby forming the YCrO₃ layer. The calcination and cooling are repeated two or more times to expand a Y₂O₃ film present on the YCrO₃ layer and accordingly detach the Y₂O₃ film therefrom, thereby forming the YCrO₃ layer on the outermost surface. The calcination of the stack may be performed, for example, at a temperature of 800 to 1200° C. under an atmospheric pressure for 1 to 20 hours, and the number of times of repeating the calcination and cooling may be, for example, 2 to 5 times, 2 to 4 times, or 2 to 3 times.

The mixture is calcinated under the oxygen atmosphere. The oxygen atmosphere can be formed, for example, by supplying oxygen into the furnace of the rotary kiln. The calcination of the mixture is preferably performed while continuously supplying the oxygen into the furnace.

A calcination temperature of the mixture is 750 to 1000° C., may be 760 to 950° C., may be 770 to 900° C., may be 780 to 880° C., or may be 790 to 850° C. A calcination time for the calcination at the calcination temperature is, for example, 1 to 20 hours, may be 5 to 15 hours, or may be 8 to 12 hours.

### Method (2) of Producing Positive Electrode Active Material

As shown in FIG. 2, the calcination step of the present method may include: a first step of obtaining a mixture of a nickel-containing compound and a lithium compound; a second step of obtaining a molded body by molding the mixture; and a third step of calcinating the molded body using a rotary kiln.

The first step, i.e., the step of obtaining the mixture may be performed by mixing the nickel-containing compound and the lithium compound. As the nickel-containing compound and the lithium compound, those described above can be used. A mixing ratio of the nickel-containing compound and the lithium compound may be set to obtain the first composite oxide having the intended composition.

The mixing of the nickel-containing compound and the lithium compound can be performed by, for example, using a mixer. As the mixer, a general mixer can be used, such as a jet mill, a ball mill, a rocking mixer, a shaker mixer, a V blender, a ribbon mixer, a Julia mixer, a Loedige mixer, or the like.

The second step is the step of obtaining the molded body by molding the mixture obtained in the first step. A method of molding the mixture is not limited as long as a molded body having a density described below can be obtained, but is preferably compression molding.

The maximum diameter of the molded body obtained in the second step is, for example, 18 to 50 mm, may be 20 to 48 mm, may be 21 to 45 mm, or may be 22 to 40 mm. When the maximum diameter of the molded body falls within the above range, a contact area of the lithium compound with the inner wall of the furnace of the rotary kiln can be reduced, thereby reducing an amount of Cr to be introduced into the first composite oxide. Moreover, the molded body can be efficiently calcinated. On the other hand, when the maximum diameter of the molded body becomes small, the contact area of the lithium compound with the inner wall of the furnace tends to be increased. When the maximum diameter of the molded body becomes large, the molded body is less likely to be calcinated sufficiently to the inside thereof, or it takes time to calcinate the molded body and therefore the molded body is less likely to be efficiently calcinated. In the present specification, the maximum diameter of the molded body refers to a maximum length among lengths connecting any two points on the outer periphery of the molded body (lengths when connecting two points so as to pass through the inside of the molded body).

The density of the molded body obtained in the second step is, for example, 1.5 to 4 g/cm³, may be 1.5 to 4.0 g/cm³, is preferably 1.6 to 3.5 g/cm³, may be 1.8 to 3.0 g/cm³, may be 2.0 to 2.8 g/cm³, or may be 2.0 to 2.5 g/cm³. When the density of the molded body is within the above range, cracking of the molded body at the time of the calcination can be suppressed, with the result that the calcination can be efficiently performed. On the other hand, when the density of the molded body becomes small, the molded body is likely to be cracked by the calcination in the third step. When the density of the molded body becomes large, oxygen is less likely to enter the inside of the molded body, with the result that the molded body is less likely to be calcinated sufficiently to the inside thereof or it takes time to calcinate the molded body and the molded body is therefore less likely to be calcinated efficiently.

The shape of the molded body obtained in the second step is not particularly limited, but is preferably a spherical shape, an elliptic spherical shape, or a cylindrical shape, and is preferably the elliptic spherical shape or cylindrical shape. When the molded body has the above shape, the contact area thereof with the inner wall of the furnace of the rotary kiln can be reduced, thereby reducing the amount of Cr to be introduced into the first composite oxide. Moreover, since the above shape of the molded body is a shape having reduced acute portions as compared with a prismatic shape or the like, the molded body can be suppressed from being formed into a powder form due to the acute portions being cut off when performing the calcination using the rotary kiln in the third step. The molded body having the elliptic spherical shape or cylindrical shape is more preferable than the molded body having the spherical shape because the molded body having the elliptic spherical shape or cylindrical shape is readily moved at a speed suitable for the calcination in the rotary kiln used in the third step.

The molded body may have a single-layer structure obtained by molding the mixture, or may have a multilayer structure with two or more layers having a core layer formed by molding the mixture and a coating layer that coats the core layer. The core layer may be formed by performing compression molding onto the mixture. In the molded body (hereinafter, also referred to as “multilayer molded body”) having the core layer and the coating layer, the coating layer may coat the entire surface of the core layer or may coat a part of the core layer. The coating layer preferably coats 70% or more, may coat 80% or more, or may coat 90% or more of the entire surface of the core layer. The multilayer molded body may have, for example, a three-layer structure in which the coating layer, the core layer, and the coating layer are stacked in this order.

The coating layer preferably includes a second lithium transition metal composite oxide (hereinafter, also referred to as “second composite oxide”), and more preferably includes the second composite oxide and a binder. Since the coating layer includes the second composite oxide, the core layer formed using the mixture including the lithium compound is less likely to be exposed. Therefore, in the calcination of the third step, the inner wall of the furnace of the rotary kiln and the lithium compound are less likely to be in direct contact with each other, with the result that Cr serving as an impurity can be further suppressed from being introduced into the first composite oxide.

The second composite oxide is not particularly limited as long as the second composite oxide is an oxide including lithium and a transition metal. The second composite oxide preferably has the composition described with regard to the first composite oxide, and is more preferably the first composite oxide produced by the present method. The second composite oxide may have the same composition as that of the first composite oxide included in the molded body, or may have a composition different therefrom. The coating layer may include, for example, the positive electrode active material produced by the present method, i.e., the positive electrode active material including the first composite oxide. The composition of the second composite oxide can be determined by the ICP-AES as described with regard to the first composite oxide.

The coating layer may include a binder to improve coating of the core layer. When the second composite oxide is mixed with the binder, granularity of the second composite oxide can be improved, thereby improving the coating of the core layer with the coating layer.

The binder includes one or more selected from a group consisting of polyvinylidene difluoride (PVdF), carboxymethyl cellulose (CMC), polyvinyl alcohol (PVA), and polyacrylamide (PAM), and preferably includes the PVdF. The binder is used to improve the granularity of the second composite oxide, and therefore may be 0.1 to 5.0 mass %, 0.5 to 3.0 mass %, or 0.8 to 2.0 mass % with respect to the total amount of the second composite oxide.

The molded body can be obtained by molding the mixture using a molding machine, and can be obtained, for example, by performing compression molding onto the mixture using a powder molding machine. As the powder molding machine, a general powder molding machine can be used, such as a hydraulic pressing machine, a static-pressure pressing machine, a briquetting machine, a single punch tablet press machine, a rotary type tableting machine, or the like.

A method of forming the multilayer molded body is not particularly limited; however, for example, the multilayer molded body can be obtained by simultaneously molding the material for forming the coating layer and the mixture for forming the core layer. For example, the multilayer molded body can be obtained by stacking a layer of the material including the second composite oxide and a layer of the mixture and then molding the stack. When the coating layer includes the binder, the multilayer molded body can be obtained, for example, as follows. First, the second composite oxide and the binder are mixed and are dispersed in a solvent such as N-methyl-2-pyrrolidone (NMP), and then the NMP is volatilized and removed by heating, thereby obtaining a granulated object including the second composite oxide and the binder. Then, the granulated object is introduced into a mold, the mixture is introduced thereon, the granulated object is further introduced, and then they are subjected to compression molding, thereby obtaining the multilayer molded body. The molding when forming the multilayer molded body may be compression molding.

The third step is the step of calcinating, using the rotary kiln, the molded body obtained in the second step. As the rotary kiln, those described above can be used. Examples of the calcination conditions of the molded body include the conditions described with regard to the calcination conditions for the mixture described above.

### Method of Producing Positive Electrode Plate

A method of producing a positive electrode plate according to the present embodiment is a method of producing a positive electrode plate using a positive electrode active material, and the positive electrode active material is produced by the present production method.

The positive electrode plate can have a positive electrode current collector foil and a positive electrode active material layer formed on one surface or each of both surfaces of the positive electrode current collector foil. The positive electrode active material is included in the positive electrode active material layer, and the positive electrode active material layer can further include at least one of a binder and a conductive material. The positive electrode active material layer can be formed in the following manner: a positive electrode slurry obtained by adding a solvent such as N-methyl-2-pyrrolidone (NMP) to the materials for forming the positive electrode active material layer, such as the positive electrode active material, the binder, and the conductive material is applied to the positive electrode current collector foil, which is then dried and compressed.

The positive electrode current collector foil is, for example, a metal foil formed using an Al material such as Al or an Al alloy. Examples of the binder includes: a fluororesin such as polyvinylidene difluoride (PVdF) or polytetrafluoroethylene; a cellulose-based resin such as carboxymethyl cellulose (CMC), methyl cellulose, and hydroxypropyl cellulose; and styrene-butadiene rubber, and one or more of these can be used. Examples of the conductive material include a carbon material. Examples of the carbon material include a fibrous carbon such as a carbon nanotube, carbon black, and the like, and one or more of these can be used.

### Method of Producing Non-Aqueous Electrolyte Secondary Battery

A method of producing a non-aqueous electrolyte secondary battery (secondary battery) according to the present embodiment is a method of producing a secondary battery using the above-described positive electrode plate, and the positive electrode plate is produced by the above-described method of producing a positive electrode plate.

The secondary battery can include an electrode assembly including the positive electrode plate, and a non-aqueous electrolyte solution, and may have a battery case that accommodates the electrode assembly and the non-aqueous electrolyte solution. As the battery case and the non-aqueous electrolyte solution, a known battery case and a known non-aqueous electrolyte solution each used in a secondary battery may be used.

The electrode assembly may include the above-described positive electrode plate, a negative electrode plate, and a separator. In the electrode assembly, the positive electrode active material layer of the positive electrode plate and a negative electrode active material layer of the negative electrode plate face each other with the separator being interposed therebetween. The electrode assembly may be of a stacked type in which the positive electrode plate, the negative electrode plate, and the separator are stacked, or may be of a wound type in which a strip-shaped stack in which a strip-shaped positive electrode plate, a strip-shaped negative electrode plate, and a strip-shaped separator are stacked is wound. The wound type electrode assembly may have a flat shape due to pressing after winding the stack. Generally, the negative electrode plate has a negative electrode current collector foil and a negative electrode active material layer. As the negative electrode current collector foil, the negative electrode active material layer, and the separator, a known negative electrode current collector foil, a known negative electrode active material layer, and a known separator used in a secondary battery may be used.

### Disclosure for Rotary Kiln

The rotary kiln used for the production of the positive electrode active material has been described above; however, the rotary kiln can be used except for the production of the positive electrode active material. The present disclosure also discloses the rotary kiln that can be used for the production of the positive electrode active material and other purposes as described below. The rotary kiln of the present disclosure can be of external heating type.

The rotary kiln of the present disclosure has the furnace, and the layer of yttrium-chromium composite oxide (YCrO₃ layer) is formed on the outermost surface of the inner wall of the furnace. As long as the YCrO₃ layer is formed on the outermost surface of the inner wall of the furnace, the furnace may be entirely composed of YCrO₃, or a portion of the furnace other than the YCrO₃ layer may be composed of a material other than YCrO₃.

The rotary kiln of the present disclosure has the furnace, and the furnace may have the base material layer composed of the alloy including Cr, and the YCrO₃ layer that coats the base material layer and that is formed on the outermost surface of the furnace on the inner wall side. The ratio of coating of the base material layer with the YCrO₃ layer, the material for forming the base material layer, and the like can be set as described with regard to the method of producing a positive electrode active material.

The rotary kiln including the furnace having the base material layer and the YCrO₃ layer can include the step of forming the YCrO₃ layer by performing thermal spraying of yttria (Y₂O₃) onto the base material layer composed of the alloy including Cr. Examples of the method of forming the YCrO₃ layer on the base material layer include the method described with regard to the method of producing a positive electrode active material.

### EXAMPLES

Hereinafter, the present disclosure will be described more specifically with reference to examples and comparative examples.

### Example 1

### Preparation of Mixture

A nickel composite oxide including Ni, Co, and Mn at a ratio of Ni:Co:Mn=83:5:12 (molar ratio) was prepared as a nickel-containing compound, and lithium hydroxide monohydrate (average particle size (D50): 10 μm) was prepared as a lithium compound. The nickel-containing compound and the lithium compound were mixed to attain a ratio of Li:Ni:Co:Mn=1.06:0.83:0.05:0.12 (molar ratio), thereby obtaining a mixture (first step).

### Production of Molded Body

5.0 g of the mixture was introduced into a mold for powder molding (“DT6025A-2025” provided by NPa SYSTEM). The mixture in the mold was subjected to compression molding at 20 MPa using a hydraulic pressing machine (provided by RIKEN KIKI), thereby obtaining a molded body having a cylindrical shape with a diameter of 20 mm×a height of 10 mm and having a density of 2.2 g/cm³ (second step). The maximum diameter of the molded body was 22.4 mm.

### Preparation of Metal Plate with YCrO₃ Layer

A SUS310S plate having a size of 100 mm×100 mm was prepared as a material for simulating the base material layer of the furnace that was the alloy including Cr and that was included in the rotary kiln. Thermal spraying of yttrium (Y₂O₃) powder was performed onto the SUS310S plate to form a Y₂O₃ layer having a thickness of 100 μm, thereby obtaining a stack of the SUS310S plate and the Y₂O₃ layer. Next, the stack was calcinated at 1000° C. for 10 hours under an atmospheric pressure, and was then left to be cooled so as to diffuse Y₂O₃ in the chromium oxide layer precipitated on the SUS310S plate, thereby forming a layer of yttrium-chromium composite oxide (YCrO₃ layer). The calcination and cooling were repeated twice to thermally expand the Y₂O₃ film on the YCrO₃ layer and accordingly detach the Y₂O₃ film therefrom. Thus, the SUS310S plate (hereinafter, also referred to as “metal plate with YCrO₃ layer”) having its outermost surface on which the YCrO₃ layer was formed was obtained.

### Calcination Step

The molded body was placed on the YCrO₃ layer of the metal plate with YCrO₃ layer, was placed in the electric furnace, and was calcinated at 805° C. for 10 hours under an oxygen atmosphere (third step), thereby obtaining a lithium transition metal composite oxide as a positive electrode active material. A content of Cr in the positive electrode active material was measured by ICP (Inductively Coupled Plasma) atomic emission spectrometry (ICP-AES). Specifically, the measurement was performed in accordance with the general rules for atomic emission spectrometry in JIS K 0116:2014, and a high-resolution ICP atomic emission spectrometry apparatus (“PS3500DDII” provided by Hitachi High-Tech Corporation) was used for analysis with the lithium transition metal composite oxide being dissolved by an alkali melting method and being diluted to a predetermined amount with ultrapure water, tartaric acid, or hydrochloric acid. A result is shown in Table 1.

### Comparative Example 1

### Preparation of Metal Plate with Chromium Oxide Film

A SUS310S plate having a size of 100 mm×100 mm was prepared as a material for simulating the base material layer of the furnace that was the alloy including Cr and that was included in the rotary kiln. The SUS310S plate was calcinated at 1000° C. for 10 hours under an atmospheric pressure to obtain an SUS310S plate (hereinafter, also referred to as “metal plate with chromium oxide film”) having its outermost surface on which a chromium oxide film was formed.

### Calcination Step

The molded body was calcinated in the same procedure as in Example 1 except that the metal plate with chromium oxide film was used instead of the metal plate with YCrO₃ layer, thereby obtaining a lithium transition metal composite oxide as a positive electrode active material. As described in Example 1, a content of Cr in the positive electrode active material was measured by the ICP-AES. A result is shown in Table 1.

### Comparative Example 2

The mixture prepared in the procedure of Example 1 was placed on the metal plate with chromium oxide film as prepared in the procedure of Comparative Example 1, and they were placed in the electric furnace and were calcinated at 805° C. for 10 hours under an oxygen atmosphere, thereby obtaining a lithium transition metal composite oxide as a positive electrode active material. As described in Example 1, a content of Cr in the positive electrode active material was measured by the ICP-AES. A result is shown in Table 1.

TABLE 1

| | | Object Calcinated in | Content of |
|---|---|---|---|
| | Type of Metal Plate | Calcination Step | Cr [ppm] |
| Example 1 | Metal Plate with | Molded Body | 0.7 |
| | YCrO₃ Layer | | |
| Comparative | Metal Plate with | Molded Body | 19.2 |
| Example 1 | Chromium Oxide Film | | |
| Comparative | Metal Plate with | Mixture | 143 |
| Example 2 | Chromium Oxide Film | | |

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A method of producing a positive electrode active material including a lithium transition metal composite oxide, the method comprising calcinating a mixture of a nickel-containing compound and a lithium compound introduced into a furnace of a rotary kiln at 750 to 1000° C. under an oxygen atmosphere, wherein
the nickel-containing compound is at least one of a nickel-containing hydroxide and a nickel-containing oxide, and
a layer of yttrium-chromium composite oxide is formed on an outermost surface of an inner wall of the furnace.

2. The method of producing a positive electrode active material according to claim 1, wherein
the layer coats a base material layer of the furnace, and
the base material layer is composed of an alloy including Cr.

3. The method of producing a positive electrode active material according to claim 2, wherein the layer is formed by performing thermal spraying of yttria onto the base material layer.

4. The method of producing a positive electrode active material according to claim 2, wherein the alloy including the Cr further includes Fe and Ni.

5. The method of producing a positive electrode active material according to claim 1, further comprising obtaining a molded body by molding the mixture, wherein
in the calcinating, the molded body is calcinated.

6. The method of producing a positive electrode active material according to claim 1, wherein the lithium compound is at least one of lithium hydroxide and lithium carbonate.

7. The method of producing a positive electrode active material according to claim 1, wherein a content of Cr in the lithium transition metal composite oxide is 1 ppm or less.

8. A method of producing a positive electrode active material according to claim 1, wherein the lithium transition metal composite oxide includes Li, Ni, and Mn.

9. The method of producing a positive electrode active material according to claim 1, wherein
the lithium transition metal composite oxide includes Li, Ni, Mn, Co, and M, the M being one or more metal elements selected from a group consisting of Mg, Ca, Al, Ti, V, Cr, Fe, Cu, Zn, Zr, Nb, Mo, Ta, W, and Y, and
a molar ratio of the Li, the Ni, the Mn, the Co, and the M is Li:Ni:Mn:Co:M=a:x:y:z:t, where the a, the x, the y, the z, and the t satisfy 1.0≤a≤1.3, x+y+z+t=1, 0.25≤x≤0.9, 0<y≤0.6, 0<z≤0.6, and 0<t≤0.1.

10. A method of producing a positive electrode plate using a positive electrode active material, wherein
the positive electrode active material is produced by the method of producing a positive electrode active material according to claim 1.

11. A method of producing a non-aqueous electrolyte secondary battery including a positive electrode plate, wherein
the positive electrode plate is produced by the method of producing a positive electrode plate according to claim 10.
